(19) United States
(12) Patent Application Publication
(10) Pub. No.: US 2001/0052686 A1
(43) Pub. Date: Dec. 20, 2001

(54) Bicycle trailer

(76) Inventor: Edward S. Galik, Ventura, CA (US)

Correspondence Address: KENNETH J HOVET LAW OFFICES, 4476 MARKET ST, SUITE 601, VENTURA, CA, 93003, US

(21) Appl. No.: 09/886,842

(22) Filed: Jun. 19, 2001

Related U.S. Application Data
(60) Provisional application No. 60/212,788, filed on Jun. 19, 2000.

(51) Int. Cl. B62H 1/00; B62J 1/00

(52) U.S. Cl. 280/292; 280/504

(57) ABSTRACT

A trailer assembly includes a front segment and a rear segment. The front segment includes a pair of opposed front segment tubes having straight portions which are fixed to a mounting bar. The straight portions merge into arcuate portions symmetrically oriented about an axis co-extensive with the mounting bar and that define a front opening. A hitch block is fixed to the other end of the mounting bar. The rear segment includes a pair of rear segment tubes with linear portions that merge into curved portions that are symmetrically oriented about the longitudinal axis and define a rear opening. The linear portions are spaced apart to define a wheel gap and a wheel is provided in the wheel gap. For operation, the front portion of a surfboard or similar rigid structure is urged forward into the front opening to engage the arcuate portions. The rear portion of the rigid structure is inserted into the rear opening for frictional engagement with the curved portions. With the rigid structure in this position, the hitch block is connected to a bicycle for transport.

This application claims priority from Provisional Application Serial No. 60/212,788, which was filed Jun. 19, 2000.

### FIELD OF THE INVENTION

The present invention pertains to trailers. The invention is particularly, but not exclusively, useful as a trailer which can be hitched to a bicycle or a person for safe and effective transportation of a surfboard or other elongated items.

### BACKGROUND OF THE INVENTION

Surfboards provide enjoyment and recreation for many users throughout the world. Of course, in order to enjoy surfing, the surfboard must be transported to the water. For motor vehicles, surfboard transportation is not a difficult issue. A rack which is adapted to hold the surfboard is attached to the roof or trunk of the vehicle, and the vehicle is driven to the water.

For other modes of transportation, however, the transportation of a surfboard is not as easy as that of a motor vehicle. Specifically, many people live within bicycling distance of the beach and ride their bicycles to the beach. In order to transport the surfboard, the bicyclist typically tucks the surfboard under one arm and steers the bicycle with the other arm.

Transportation of a surfboard in such a manner is extremely unsafe for a number of reasons. First, the unwieldy nature of the surfboard forces the bicyclist to perch precariously on the bicycle, and the bicyclist may fall off the bicycle during transport. Second, with the surfboard tucked under one arm, the forward end of the surfboard protrudes past the front wheel. When this occurs, the surfboard blocks the front wheel from turning in one direction and the bicyclist cannot turn towards the arm holding the surfboard. Third, if the bicycle brakes are mounted on the handlebars, a minimum of fifty percent of the braking capacity of the bicycle is lost, as one hand is occupied holding the surfboard. Thus, if the bicyclist holds the surfboard under one arm, the bicyclist is not sitting on the bicycle normally, can only turn in one direction and cannot effectively operate the brakes to stop the bicycle. This, of course, is an extremely dangerous situation for the bicyclist, and should be avoided.

In addition to bicyclists, some surfing enthusiasts live within walking distance of the beach. Even for bicyclists, once at the beach, the bicyclist may have to transit a fair distance over sand/uneven terrain while carrying the surfboard in order to reach the water for surfing. What is desired is a bicycle surfboard trailer that can be adapted to pedestrian use for easier, more convenient transport of the surfboard over rough terrain.

In addition to the above considerations, the surfboard trailer should be easily dissembled or stored in a minimum of space. More specifically, the surfboard trailer should be able to be locked to the bicycle with a bicycle chain when not in use, and the surfboard trailer should be relatively compact and should not take up space.

U.S. Pat. No. 3,659,761, which issued to Wesson for an invention entitled “Bicycle Side Rack For Surfboard”, discloses a carrier rack with fore and aft somewhat L-shaped brackets extending transversely from one side of a bicycle frame. The brackets cooperate with corresponding adjustable braces which are looped at least partially around the surfboard forward and rearward sections to resiliently suspend the surfboard while the surfboard rests on the L-shaped brackets for transport. For the device as disclosed by Wesson, however, the shape and orientation of the brackets cause the surfboard to extend beyond the front wheel of the bicycle when loaded thereon. Accordingly, the bicycle cannot be steered in one direction for the device as disclosed by Wesson.

With respect to pedestrian transportation of surfboards, German Patent No. 2,900,283 discloses a somewhat A-shaped frame which is formed with an aperture and which has a pair of opposing wheels mounted to the bottom of the legs for the A-shape. One end of the surfboard is inserted into the aperture of the A-shape, and the pedestrian continues to hold the other end of the surfboard. German patent No. 2,900,283, however, does not disclose an additional shoulder harness segment that is adapted to rest on a pedestrian shoulder. With this configuration, the hands of the pedestrian are left free to carry other items, and the weight of the surfboard is shifted to the shoulders, as opposed to the arms, in order to provide an enhanced mechanical advantage, which further facilitates pedestrian transport of the surfboard.

In light of the above, it is an object of the present invention to provide a bicycle trailer which safely and effectively transports surfboards or other elongated articles. It is another object of the present invention to provide a bicycle trailer which allows for normal operation of a bicycle with two hands and which does not inhibit steering of the bicycle. It is another object of the present invention to provide a bicycle trailer that allows for quick and easy unloading of a surfboard and the like which can be compactly stored when not in use. It is another object of the present invention to provide a bicycle trailer that can be adapted for pedestrian use in order to provide a mechanical advantage for transporting a surfboard or other elongated items over rough, uneven terrain. It is another object of the present invention to provide a bicycle trailer that is relatively easy to manufacture in a cost effective manner.

### SUMMARY OF THE INVENTION

A trailer assembly in accordance with the present invention includes a front segment and a rear segment. The front segment is adapted for engagement with the front portion of a rigid structure such as a surfboard or travois at one end, and with a bicycle or pedestrian at the other end. The rear segment is adapted to engage the rear portion of the rigid structure at one end and includes a wheel to facilitate transportation at the other end.

The front segment is formed with a pair of front segment tubes. Each front segment tube has a straight portion which merges into an arcuate portion. The front segment tubes are arranged so that the arcuate portions are symmetrically oriented about a longitudinal axis. Once oriented in this manner, the straight portions are attached to the segment end of a mounting bar that is co-extensive with the longitudinal axis. The arcuate portions define a front opening for receiving the front portion of the surfboard or travois. Importantly, the front opening is sized so that the rigid structure is positioned behind the bicycle and does not hinder maneuverability of the bicycle during operation as described below.

A hitch block is attached to the other end of the mounting bar. The hitch block is formed with a stem opening for receiving a bicycle seat post in order to attach the front segment to a bicycle.

In lieu of the mounting bar/hitch block structure, the assembly of the present invention includes a shoulder harness that is attached to the front segment tubes to adapt the assembly for use by a pedestrian. The shoulder harness includes a harness crossbar that is transversely connected to the ends of the straight portions. The harness also includes a pair of shoulder tubes, each having an upper curved section and a lower curved section that cooperate to give the shoulder tubes a backwards “S” shape when viewed in side elevation. With the shoulder tubes spaced-apart, the ends of the lower curved sections are fixed to the harness crossbar. The upper curved sections engage the shoulders of a pedestrian during operation of the assembly.

The rear segment comprises a pair of rear segment tubes. In similar fashion to the front segment tubes, the rear segment has opposing linear portions that merge into curved portions symmetrically oriented about the same longitudinal axis described above. The rear segment tubes are spaced-apart to define a wheel gap and the linear portions are connected to each other with a spacer and an axle. When connected in this manner, the curved portions define a rear opening for receiving the rear portion of the rigid structure. It is important that the rear opening be sized so that when the rigid structure is engaged with the curved portions of the rear segment tubes during operation, the rigid structure is spaced-apart from the ground and does not drag.

A wheel is positioned within the wheel gap and rotatably attached to the axle so that the wheel rotates freely within the gap.

The assembly of the present invention includes a travois. The travois has two longitudinal rails which are connected to two crossbars. Specifically, one rail is connected to one end of each crossbar, and the other longitudinal rails is connected to the other end of each respective crossbar. A cargo net is overlaid over the support rails and crossbars and fixed thereto to facilitate carrying of cargo. The longitudinal rails are spaced-apart a distance which allows for engagement with the arcuate portions of the front segment tubes and the curved portions of the rear segment tubes as discussed below.

During operation, the rigid structure (the surfboard or travois) is inserted into the front opening and urged forward until the structure frictionally engages the arcuate portions of the front segment tubes. Similarly, the rear portion of the rigid structure is inserted into the rear opening to frictionally engage the curved portions of the rear segment tubes. Next the hitch block is connected to the bicycle for transport. The unique nature of the assembly allows for bicycle transport of the rigid structure with a minimum hindrance to the maneuverability of the bicycle.

During transport, the weight of the rigid structure maintains frictional engagement of the structure with the front segment and rear segment. To remove the rigid structure therefrom, the arcuate portions of the front segment tubes are lifted upward and the front portion of the rigid structure is eased out of the front opening. Similarly, the curved portions of the rear segment tubes are lifted slightly upward, and the rigid structure is eased out of the rear opening. The front segment and rear segment are then compactly stored in a minimum of space, or locked to the bicycle and/or a bicycle rack.

### BRIEF DESCRIPTION OF THE DRAWINGS

The novel features of this invention will be best understood from the accompanying drawings, taken in conjunction with the accompanying description, in which similar characters refer to similar parts, and in which:

FIG. 1 is a side elevational view of the bicycle trailer of the present invention.

FIG. 2 is a top plan view of the trailer of FIG. 1.

FIG. 3 is a top plan view of the front segment of the trailer of FIG. 1.

FIG. 3a is an isometric view of the bracket for the front segment of FIG. 3.

FIG. 4 is a top plan view of the rear segment of the trailer of FIG. 1.

FIG. 5 is a top plan view of a travois in combination with the trailer of FIG. 1.

FIG. 6 is a rear elevational view of a second embodiment of the invention shown in FIG. 1 comprising an alternative rear segment.

FIG. 6a is a top plan view taken along lines 6a-6a of FIG. 6.

FIG. 7 is a side elevational view of a third embodiment of the trailer of FIG. 1.

FIG. 8 is a top plan view of the third embodiment shown in FIG. 7.

### WRITTEN DESCRIPTION OF THE PREFERRED EMBODIMENTS

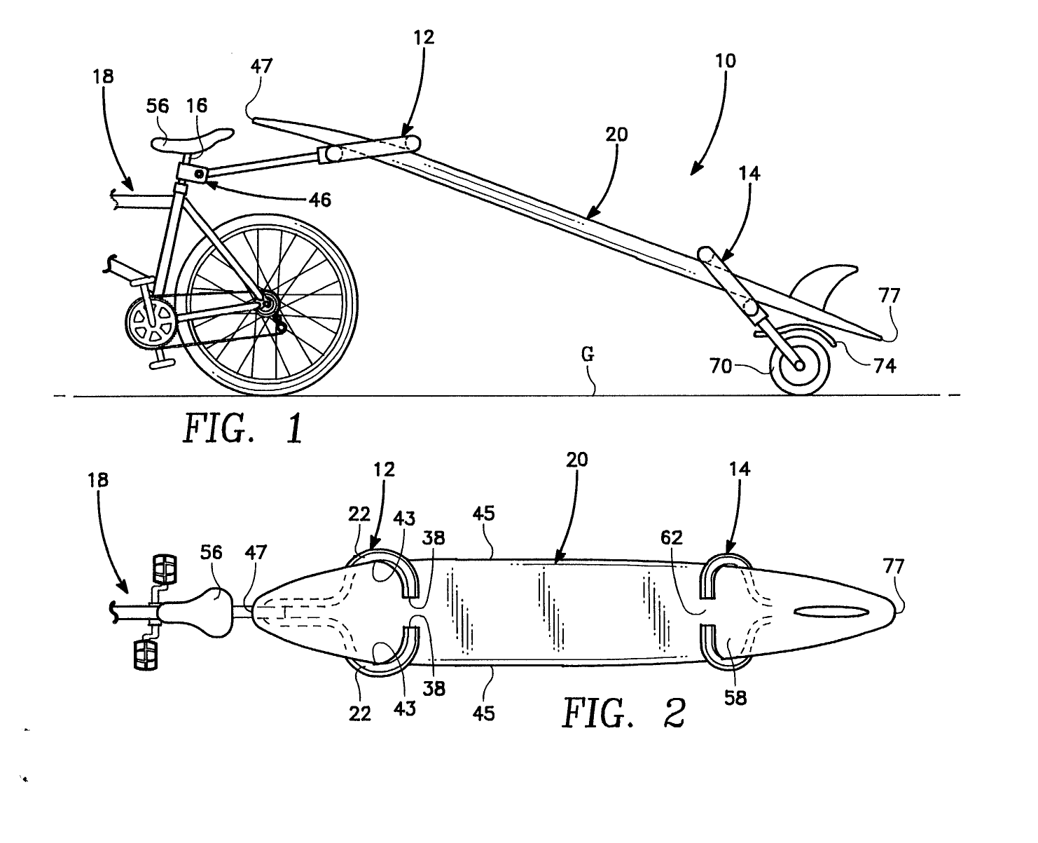

With reference now to the drawings, the bicycle trailer is shown transporting a surfboard and is generally designated by reference character 10. The trailer includes a separate front segment 12 and rear segment 14. In brief overview, the front segment is adapted to be connected to the seat post 16 of a bicycle 18 in a manner to be described. Both the front segment and the rear segment are adapted for carrying a surfboard 20, as shown in FIGS. 1-6 and as more fully described below.

Referring now to FIGS. 1-3a and 5, the structure of the front segment is shown in greater detail. Specifically, a pair of front segment tubes 22, 22 are attached to segment end 24 of mounting bar 26. Each front segment tube comprises a straight portion 28 that merges into an arcuate portion 30. Each straight portion is connected to the mounting bar with a plurality of fasteners 32 so that the arcuate portions of the front segment tubes are symmetrically opposed about longitudinal axis 34. The plane defined by the front segment tubes is coextensive with the mounting bar and with the longitudinal axis.

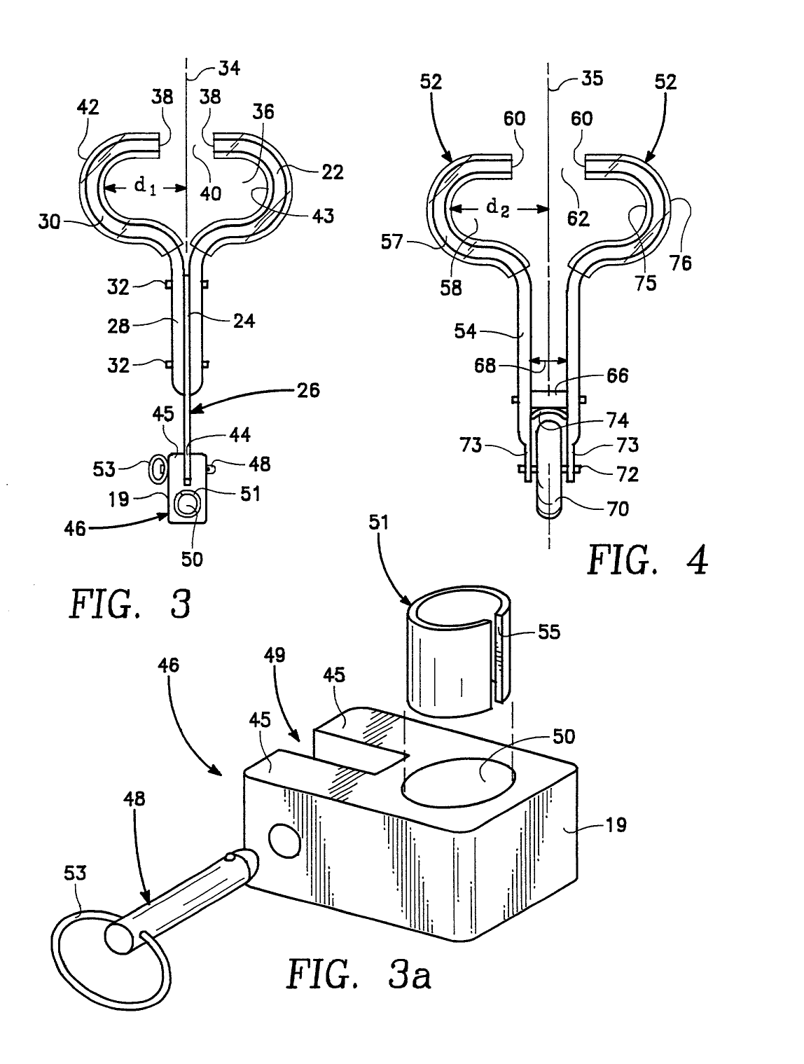

As best seen in FIG. 3, the arcuate portions flare outwardly from the longitudinal axis and establish a somewhat oval-shaped front opening 36. The ends 38, 38 of the arcuate portions are spaced-apart and define a front gap 40 therebetween that is transversely centered on longitudinal axis 34. Each arcuate portion is covered with a front arcuate sleeve 42 for preventing damage to the surfboard.

The maximum distance d₁ from the longitudinal axis to each inner surface 43 of the front arcuate sleeve 42 is important. Specifically, maximum distance d₁ is chosen so that when surfboard 20 is placed in the front segment with surfboard side edges 45, 45 contacting inner surface 43, 43 of the front arcuate sleeves 42, 42 (See FIG. 2), the front end 47 of the surfboard will be spaced rearwardly from bicycle seat 56. In the preferred embodiment, d₁ is about eight inches (d₁=8″).

Other shapes for the arcuate portion 30 are also envisioned. For example, front segment tubes 22, 22 may be bent to define a diamond-shaped front opening or a rectangular shaped front opening. The specific shape will be dictated by the size and shape of the elongated article being trailered.

A bracket 46 is used to releaseably connect mounting bar 26 to bicycle 18. The bracket comprises a block 19 from which extend bifurcated bracket arms 45, 45, as best seen in FIGS. 3 and 3a. The arms are spaced-apart to define a slot opening 49 for insertion of the hitch end 44 of mounting bar 26. The bracket arms and mounting bar hitch end include corresponding fastener openings for insertion of a cross pin 48. Preferably, the cross pin is provided with a lock ring 53 to facilitate quick connect and disconnect actions known in the art. Examples of other types of quick connect fasteners are bolt-and-wingnut combinations, U-bolts, cam-lock mechanisms and clamping devices.

The block 19 is formed with a stem opening 50 which has an internal diameter greater than the outside diameter of bicycle seat post 16. As best seen in FIG. 3a, a plurality of flexible spacers 51 are included with the bracket. Each spacer has a tube-like structure and is formed with a longitudinal slit 55. The spacers are made of a material which provides a bearing-type effect to inhibit wear during rotational movement of the bracket about the bicycle seat post.

To connect the front segment 12 to a bicycle, the bicycle seat 56 is removed, and the bicycle seat post 16 is inserted into stem opening 50. Spacers are inserted between the seat post and stem opening, and the flexible nature of the spacers allow the spacer to closely conform to the seat post while fitting within the stem opening. Spacers are added until the bracket both fits snugly, yet rotates easily around the seat post. The mounting bar hitch end 44 is inserted into slot opening 49. Upon alignment with respective fastener openings of the arms and hitch end, the cross pin 48 is passed through and releasably secured with lock ring 53.

To insure that the front segment 12 extends rearwardly along a plane that is about horizontal and above the bicycle rear wheel, the hole in the hitch end of the mounting bar is placed to permit slight upward lifting of the front segment when the front segment is attached to the bracket. The front segment tubes are attached to the segment end of the mounting bar with the same consideration in mind. The substantially horizontal orientation of the front segment facilitates engagement with a surfboard or other elongated rigid article in a manner discussed hereinafter.

Referring now to FIGS. 1-2 and 4-5, the rear segment of the trailer is shown in greater detail. As best seen in FIG. 4, the rear segment comprises a pair of opposing rear segment tubes 52, 52 that are arranged symmetrically about rear longitudinal axis 35. In similar fashion to the front segment tubes, each rear segment tube is formed with a linear portion 54 that merges into a curved portion 57. The curved portions further define an oval-shaped rear opening 58 and the curved segment ends 60, 60 define a rear gap 62. Rear curved sleeves 76, 76 are each placed around a respective curved portion 57, 57 as best seen in FIG. 4.

In the linear portion of the rear segment tubes, a lower spacer 66 is mounted between the rear segment tubes. The spacer orients the rear segment tubes in a spaced-apart relationship that is symmetrical about rear longitudinal axis 35, and the distance between the linear portions defines a wheel gap 68, as shown in FIG. 4. A wheel 70 is mounted to an axle 72 that extends transversely across wheel ends 73, 73 of linear portions 54, 54. The spacing allows the wheel to rotate freely within the wheel gap. A fender 74 is mounted to the lower spacer, to protect the surfboard from mud and debris which may be flung from the wheel during movement of the trailer.

The distance d₂ from longitudinal axis 35 to inner curved surface 75 of the rear curved sleeve is chosen so that when surfboard 20 is placed into rear opening 58 with side edges 45, 45 contacting inner curved surfaces 75, 75, the rear end 77 of the surfboard will not touch the ground G, fender 74 or wheel 70 (See FIG. 1). Like the arcuate portion of the front segment tube 12, other shapes for the rear opening are also envisioned. For example, the rear opening could have a circular or polygonal shape in outline.

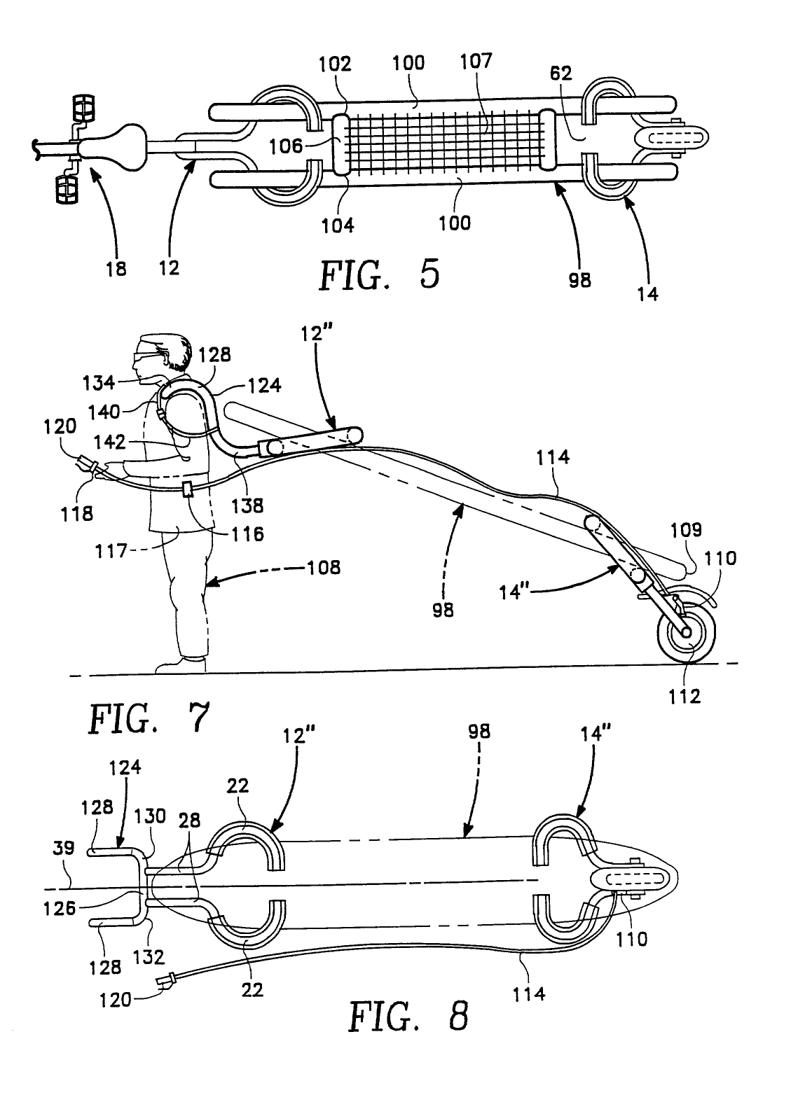

Referring now to FIGS. 5 and 7, a travois 98 for the trailer of the present invention can be shown. The travois is intended to provide a general purpose support structure for trailering a variety of items. It comprises a pair of opposing support rails 100, 100 that are permanently fastened to opposite ends 102, 104 of a plurality of spaced-apart crossbars 106, as shown in FIG. 5. The length of the crossbars is chosen so that the support rails of the travois engage the arcuate portion of the front segment and the curved portion of the rear segment in the same manner as a surfboard. The travois is preferably fitted with a cargo net 107 that is attached to the rails and crossbars in a manner known in the art. With this configuration, the travois provides added utility for the trailer of the present invention.

In the preferred embodiment, the travois support rails 100, 100 are oriented about parallel to each other, and the crossbars are oriented substantially perpendicularly to the support rails, as shown in FIG. 5. Other structural configurations are possible as dictated by the specific items being carried and consumer aesthetics. For example, the support rails may have an intersecting configuration and/or the crossbars may be connected obliquely to the support rails, provided the overall travois fits within the front segment and rear segment openings in the same manner as described above.

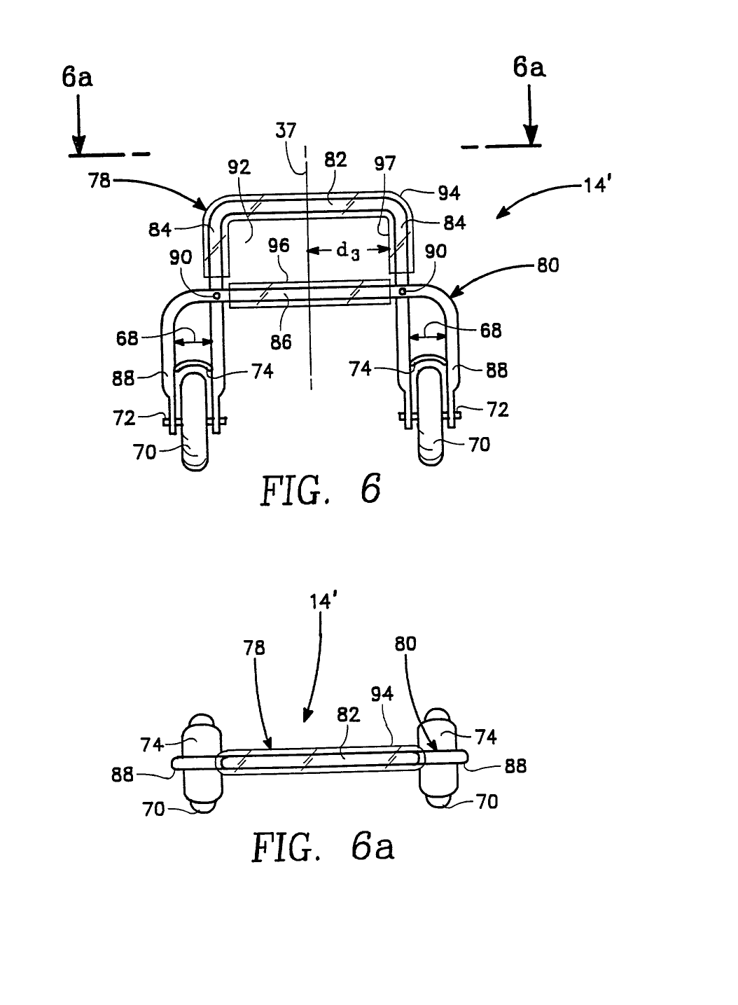

Referring now to FIG. 6, a second embodiment of the invention is shown comprising an alternative rear segment 14′ of the trailer. Specifically, the alternative rear segment has a first segment tube 78 and a second segment tube 80. The first segment tube has an upper horizontal leg 82 with opposing ends that merge into downwardly extending inner vertical legs 84, 84. The inner vertical legs extend downwardly and orthogonally to upper horizontal leg 82 to give the first segment tube a somewhat inverted U-shape. Similarly, the second segment tube has a lower horizontal leg 86 that merges into opposing outer vertical legs 88, 88 that project downwardly from and perpendicular to the lower horizontal leg to give the second segment tube a somewhat inverted U-shape. The length of lower horizontal leg 86 is greater than that of upper horizontal leg 82, and the height of inner vertical legs 84, 84 is greater than the height of outer vertical legs 88, 88.

For assembly, the first segment tube 78 is oriented symmetrically about third longitudinal axis 37 with upper horizontal leg perpendicular to third longitudinal axis 37. Second segment tube 80 is also oriented symmetrically about third longitudinal axis 37 and is oriented so that lower horizontal leg 86 is about parallel to upper horizontal leg 82 of first segment tube 78. Once oriented in this manner, first segment tube 78 is fixed to second segment tube 80 by attaching each lower horizontal legs 86, 86 to a respective inner vertical leg 84, 84 proximate midpoints 90, 90.

Because of the length relationship between the lower horizontal leg and upper horizontal leg discussed above, a pair of opposing wheel gaps 68, 68 are established between a respective inner vertical leg 84 and outer vertical leg 88. This enables a pair of wheels 70, 70 to be rotatably mounted to axles 72, 72 extending between a respective inner vertical leg and a respective outer vertical leg. A fender is positioned in each gap above the wheel and mounted to a respective inner vertical leg and outer vertical leg, to protect the surfboard from mud and debris as discussed above.

Because of the above-discussed height relationships between inner vertical legs and outer vertical legs, as well as the above-discussed length relationships between upper horizontal leg and lower horizonal leg, an rectangular shaped opening 92 is created where first segment tube 78 and second tube 80 are connected. As shown in FIG. 6, the rectangular aperture is bounded by upper horizontal leg, lower horizontal leg, and portions of the inner vertical legs. To prevent damage to the surfboard, a sleeve 94 is attached to upper horizontal leg and portions of inner vertical legs. Similarly, a lower horizontal sleeve 96 attached to lower horizontal leg 86.

Distance d₃ from longitudinal axis 37 to inner vertical surface 97 of inner vertical leg 84 is chosen so that when surfboard 20 is placed within rectangular opening 92 with side edges 45, 45 contacting inner vertical surfaces 97, 97, the rear end 77 of the surfboard will clear the ground.

Referring now to FIGS. 7 and 8, a third embodiment of the invention adapted for use by a pedestrian 108 is shown. Rear segment 14″ has the same structure as that described in FIG. 1. For the third embodiment, however, a brake 110 is mounted to the linear portion of one rear segment tube for selective engagement with wheel rim 112 in a manner known in the prior art. A brake cable 114 is connected to the brake and extends forward therefrom past the front segment. A clip 116 is attached to the brake cable to allow for attachment of the brake cable to pedestrian clothing 117. At forward cable end 118, a handbrake 120 is mounted to the cable for selective operation of the brake by the pedestrian.

The front segment 12″ for the third alternative embodiment also includes a pair of opposing front segment tubes. The front segment tubes have the same structure described above and shown in FIG. 3 and have a symmetrical orientation with respect to fourth horizontal axis 39 shown in FIG. 7. Instead of being connected to a mounting bar and hitch combination, however, the forward segment tubes are connected to a shoulder harness 124.

The shoulder harness comprises a harness crossbar 126 and a pair of opposing shoulder tubes 128 that are mounted to opposite ends 130, 132 of harness crossbar 126. The shoulder tubes each have an upper curved section 134 that merges downwardly into a lower curved section 138. As best seen in FIG. 7, with front segment 12″ oriented with the front segment tube extending rearwardly from pedestrian 108, the upper curved section is shaped to conform to the pedestrian shoulders. Lower curved section arcs away from the pedestrian and towards the front segment tubes. This orientation gives the shoulder tubes a somewhat backwards S-shape when viewed in side elevation, as best seen in FIG. 7.

For assembly, each lower curved section is attached to a respective end 130, 132 of the harness crossbar. The straight portions 28, 28 of the front segments are then attached to harness crossbar 126 to give the front segment tubes the orientation about axis 34 described above.

As best seen in FIG. 8, once assembled to the harness crossbar, the shoulder tubes lie in substantially parallel vertical planes. By cross-referencing FIGS. 7 and 8, it can be seen that both vertical planes are substantially orthogonal to a horizontal plane containing both the harness crossbar and front segment tubes 22, 22.

As shown in FIGS. 7-8, the shoulder harness includes an upper strap 140 that is attached to upper curved segment 134 and a lower strap 142 that is attached to lower curved section 138. With the shoulder harness positioned on the pedestrian, the lower strap is routed under the arm and attached to the upper strap in a manner well known in the prior art. As shown in FIG. 8, a surfboard is positioned within the trailer for transport. As indicated by FIG. 7, however, the travois 98 could also be placed in the third pedestrian embodiment for transport.

From the above, it can be seen that the rigid support structure provides an integral part of the trailer. The end portions of the structure are held within respective segment openings by the weight of the structure and the leverage exerted by the relatively fixed angular connection of the front segment to the bicycle and the uplifting force provided by the rear segment. The counteracting forces hold the structure securely against the respective inner surfaces of the front and rear segments even while the bicycle turns corners or moves over rough terrain.

Once the cyclist's/pedestrian's destination has been reached, it is a simple matter to elevate the front segment tubes to release engagement of the structure (either a surfboard or travois) from the aforementioned inner surfaces and, then, withdraw the structure front end portion from the front segment opening. The above actions release the rear segment from its frictional engagement with the structure back end portion and allow a user to simply pull the rear segment away for subsequent stowing. Because no other mechanisms or structures are involved, the invention provides significant convenience and cost savings. The modular nature of the segments further allows for compact storage of the trailer in a minimum of space. The segments could even a positioned next to a bicycle are locked with a bicycle chain or normal length.

The materials of construction for the travois, front segment tubes, rear segment tubes, first segment tubes, second segment tubes and shoulder tubes should be relatively light, yet should have a significant strength-to-weight ratio. Examples of suitable materials are aluminum, aluminum alloys, titanium, high-density plastics and fiberglass.

The sleeve materials should provide a resilient frictional engagement surface for the surfboard, travois and whatever other support structure is being used. A preferred material is foamed polyurethane.

While the bicycle trailer, as herein shown and disclosed in detail, is fully capable of obtaining the objects and providing the advantages above stated, it is to be understood that the presently preferred embodiments are merely illustrative of the invention. As such, no limitations are intended other than as defined in the appended claims.

What is claimed is:

1. A trailer assembly for transporting an elongated rigid structure having a front portion and a rear portion, said trailer comprising:
a front segment formed with a pair of front segment tubes, said front segment tubes having opposing arcuate portions defining an front opening for receiving said front portion of said surfboard; and,
a rear segment formed with a pair of rear segment tubes, said rear segment tubes having opposing curved portions defining a rear opening for receiving said rear portion of said structure.

2. The assembly of claim 1 wherein said arcuate portions each extend into a respective straight portion, and further comprising:
a mounting bar having a segment end and a hitch end, said straight portions being attached to said segment end.

3. The assembly of claim 2 wherein said mounting bar defines a longitudinal axis, and further wherein said straight portions and said arcuate portions are symmetrically oriented about said longitudinal axis.

4. The assembly of claim 3 further comprising a hitch block, said hitch end being selectively attached to said hitch block.

5. The assembly of claim 4 wherein said hitch block is formed with a stem opening for receiving a bicycle seat post.

6. The assembly of claim 3 wherein said curved portions each extend into a respective linear portion, and further wherein said curved portions and said linear portions are symmetrically oriented about said longitudinal axis.

7. The assembly of claim 6 linear portions are spaced-apart to define a wheel gap therebetween and further comprising:
a axle having a first end attached to one of said linear portions and having a second end attached to the other of said linear portions; and,
a wheel positioned in said wheel gap and rotatably attached to said axle so that said wheel rotates within said gap.

8. The assembly of claim 3 wherein said rigid structure is a surfboard, and further wherein said arcuate portions are each spaced a distance from said longitudinal axis so that said surfboard is positioned behind said segment end when said surfboard is frictionally engaged with said arcuate portions.

9. The assembly of claim 7 wherein said rigid structure is a surfboard, and further wherein said curved portions are each spaced a sufficient distance from said longitudinal axis so that said surfboard is positioned above said wheel when said surfboard is frictionally engaged with said curved portions.

10. The assembly of claim 1 wherein said rigid structure is a travois comprising:
at least two longitudinal support rails;
at least one crossbar having a first end attached to one of said support rails and having a second end attached to another of said support rails; and,
a cargo net overlaid over said support rails and crossbars and fixed thereto.

11. The assembly of claim 10 wherein said support rails are spaced-apart in a parallel relationship.

12. The assembly of claim 11 wherein said crossbar is orthogonal to said support rails.

13. The assembly of claim 1 wherein said arcuate portions each extend into a respective spaced-apart straight portions, said assembly further comprising:
a harness crossbar transversely connected to said straight portions; and
at least one shoulder tube having an upper curved section and having a lower curved section attached to said harness crossbar to extend said shoulder tube opposite said front segments.

14. A trailer assembly for transporting an elongated rigid structure having a front portion and a rear portion, said trailer comprising:
a front segment formed with a pair of front segment tubes, said front segment tubes having opposing arcuate portions defining an front opening for receiving said front portion of said surfboard; and,
a first rear segment tube having a first horizontal leg which extends into opposing first vertical legs;
a second rear segment tube having a second horizontal leg and opposing second vertical legs; and,
said first rear segment tube being attached to said second rear segment to define a rear opening.

15. The assembly of claim 14 wherein said arcuate portions each extend into a respective straight portion, and further comprising:
a mounting bar having a segment end and a hitch end, said straight portions being attached to said segment end.

16. The assembly of claim 15 wherein said mounting bar defines a longitudinal axis, and further wherein said straight portions and said arcuate portions are symmetrically oriented about said longitudinal axis.

17. The assembly of claim 16 wherein said first rear segment tube and said second rear segment tube are symmetrically oriented around said longitudinal axis.

18. The assembly of claim 14 wherein said rear opening is bounded by said first horizontal leg, said second horizontal legs and first vertical legs.

19. The assembly of claim 15 wherein said rear opening is rectangular.

20. The assembly of claim 14 wherein said each first vertical leg cooperates with a second vertical leg to define a wheel gap and further comprising:
an axle transversely mounted in each wheel gap and having a first axle end attached to said first vertical leg and a second axle end attached to said second vertical leg; and,
a wheel mounted to said axle.
